(19) United States
(12) Patent Application Publication
(10) Pub. No.: US 2026/0228804 A1
(43) Pub. Date: Aug. 6, 2026

(54) SYSTEMS AND METHODS FOR PROVIDING PRODUCT SEARCH RESULTS

(71) Applicant: Walmart Apollo, LLC, Bentonville, AR (US)

(72) Inventors: Jon Alferness, San Francisco, CA (US); Andrew J. Grignon, Roseville, CA (US); Darrell Whitelaw, Pacific Palisades, CA (US); Steven Duval Ruilova, Solana Beach, CA (US); Matthew S. Brown, Kinnelon, NJ (US); Stephen Hadinger, Berkeley, CA (US); Gabriel H. Giraldo-Wingler, Doylestown, PA (US); Tushar P. Dadlani, San Francisco, CA (US)

(21) Appl. No.: 19/042,127

(22) Filed: Jan. 31, 2025

(51) Int. Cl. G06Q 30/0601; G06F 16/9538

(52) U.S. Cl. CPC G06Q 30/0641; G06F 16/9538

(57) ABSTRACT

In some embodiments, apparatuses and methods are provided herein useful to provide product search results. In some embodiments, a system includes a communication interface to provide a search interface of an e-commerce user interface to a plurality of user devices, a computer readable storage memory storing a product database and a set of computer executable instructions, and a control circuit configured to execute the set of computer executable instructions, causing the control circuit to: provide the search interface to a user device, receive a first query from the user device, generate, via a language model, a product list comprising a plurality of products, generate, via the language model, two or more dynamic categories; and provide, for display on the user device, the two or more dynamic categories for selection in the e-commerce user interface.

### TECHNICAL FIELD

This disclosure relates generally to e-commerce retailers, and, more specifically, to search queries.

### BACKGROUND

E-commerce retailers generally have interfaces (e.g., applications and websites) on which a user can navigate to interact with (e.g., view, add to cart, purchase, etc.) products available for purchase. In order to navigate the interface and products sold thereon, interfaces of an e-commerce retailer generally include search interfaces through which a user can enter a relevant term or phrase in order to find a listing of products related to the entered query, and pre-determined categories defining related groupings of products. Categories of current search interfaces can be limited by historical data in determining categories (i.e., categories are generated based on historical data and are static once generated) and often do not correspond with a specific intent of a customer (e.g., a search query). Accordingly, there is a need for improved search interfaces on e-commerce retailer interfaces.

### BRIEF DESCRIPTION OF DRAWINGS

Disclosed herein are embodiments of systems, apparatuses and methods pertaining to systems and method for providing product search results. This description includes drawings, wherein:

FIG. 1 is a block diagram of a search query system in accordance with some embodiments.

FIG. 2 is a block diagram of a search query system in accordance with several embodiments.

FIG. 3 is a block diagram of a search query system in accordance with some embodiments.

FIG. 4 is a block diagram of a search query system in accordance with several embodiments.

FIG. 5 is a block diagram of a search query system in accordance with some embodiments.

FIG. 6 is a block diagram of a search query system in accordance with several embodiments.

FIG. 7 is a block diagram of a search query system in accordance with some embodiments.

FIG. 8 is a block diagram of a search query system in accordance with several embodiments.

FIG. 9 is a block diagram of a search query system in accordance with some embodiments.

FIG. 10 is a flow diagram of a method of providing search results in accordance with several embodiments.

FIG. 11 is a flow diagram of a method of providing search results in accordance with some embodiments.

FIG. 12 is a flow diagram of a method of providing search results in accordance with several embodiments.

FIG. 13 is a flow diagram of a method of providing search results in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to providing product search results. In some embodiments, a system for providing product search results may include a communication interface configured to provide, via a network, a search interface of a user interface to a plurality of user devices. The system may further include a computer readable storage memory storing a product database and a set of computer executable instructions. The product database may include a plurality of product records each associated with a set of search vectors. A control circuit may be configured to execute the set of computer executable instructions, which may cause the control circuit to provide the search interface to a user device and receive a first query from the user device via the search interface. The control circuit may generate, via a language model, a product list including a plurality of products based on the first query and the product database, and generate, via the language model, two or more dynamic categories based on product vectors of the plurality of products in the product list. The control circuit may provide, for display on the user device, the two or more dynamic categories for selection in the user interface. The selection of a dynamic category may trigger the display of a subset of products in the product database associated with the dynamic category.

In some embodiments, a method for providing product search results may include providing, by a communication interface via a network, a search interface of a user interface to a plurality of user devices. The method may further include storing, on a computer readable storage memory, a product database, and a set of computer executable instructions. The product database may include a plurality of product records, each associated with a set of search vectors. The method may further include executing the set of computer executable instructions, providing the search interface to a user device, receiving a first query from the user device via the search interface, generating, via a language model, a product list including a plurality of products based on the first query and the product database, generating, via the language model, two or more dynamic categories based on product vectors of the plurality of products in the product list, and providing, for display on the user device, the two or more dynamic categories for selection in the user interface. The selection of a dynamic category may trigger the display of a subset of products in the product database associated with the dynamic category.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

Conventional search query systems and platforms utilize generalized categories to aid a user in searching for products. Current methods of creating categories (e.g., with historical data) and displaying the categories (e.g., separately from a user search query) can be inefficient and difficult to use from a user perspective. The present disclosure generally describes a user-guided recursive search query system that builds upon queries to generate dynamic categories. The described systems and methods generally generate categories and subcategories that are related to a user query and that may be used to refine product lists resultant from search queries when selected by a user. The dynamically generated, selectable categories of the present disclosure may increase intuitiveness and ease of access for users while further increasing the relevancy of generated categories to a specific user query.

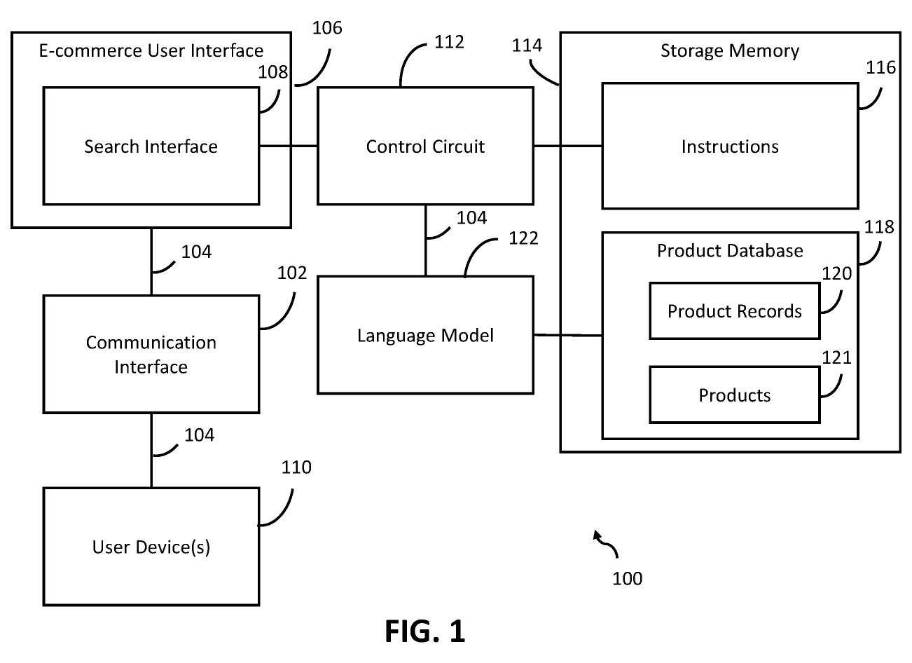

Referring to FIG. 1, a search query system 100 for providing product search results is shown in accordance with some embodiments. As shown, the search query system 100 includes a communication interface 102 that is communicatively coupled to an e-commerce user interface 106 (which may be generically referred to as a user interface) and a plurality of user devices 110 over a network 104. The search query system 100 may include a control circuit 112 communicatively coupled to the e-commerce user interface 106, a computer readable storage memory 114, and a language model 122 over the network 104. It is generally contemplated, that any of the components (i.e., the communication interface 102, the network 104, the e-commerce user interface 106, the user devices 110, the control circuit 112, the computer readable storage memory 114, and/or the language model 122) of the search query system 100 may be communicatively and/or operatively coupled to one another via the network 104.

In some embodiments, the communication interface 102 may be configured to transmit data and/or signals between two or more devices/components (e.g., the devices/components of the search query system 100 and/or devices/components in communication with the search query system 100). Examples of suitable communication interfaces 102 include, but are not limited to, ports, transceivers, communication links, and so forth allowing the search query system 100 and components thereof to communicate over a communication bus, a distributed computer, and/or a network 104. In some embodiments, the communication interface 102 may be a communication bus configured to allow at least the e-commerce user interface 106 and the user devices 110 to communicate with one another. For example, the communication interface 102 may be an intermediary application programming interface (API) to provide relevant information (e.g., product information) to be displayed on the e-commerce user interface 106. In some aspects, the communication interface 102 can include a wired connection, a wireless connection, and/or a combination of wired and wireless connections.

In some embodiments, the network 104 may be any suitable network or communication method such as, for example, a local area network (LAN), the Internet, wide area network (WAN), etc., communication link, other networks or communication channels with other devices and/or other such communications (not shown) or combination of two or more of such communication methods. There may be any combination of wired connections and/or wireless connections (e.g., Wi-Fi, Bluetooth, cellular, RF, and/or other such wireless communication) between elements of the search query system 100.

The e-commerce user interface 106 may include a search interface 108 in accordance with some embodiments. In some aspects, the search interface 108 may be provided to the user devices 110 by the communication interface 102 via the network 104. In some embodiments, the e-commerce user interface 106 may be, for example, a website and/or a mobile application associated with an e-commerce retailer. Generally, the e-commerce user interface 106 may be navigable by a user to view and/or purchase products 121 from an e-commerce retailer. In some embodiments, the e-commerce user interface 106 may be accessible via the user devices 110, such that an input made by a user via the user device 110 allows a user to navigate the e-commerce user interface 106. In one example, the e-commerce user interface 106 may be an application of an e-commerce retailer accessible on a mobile device. Example mobile devices may include, but are not limited to, cellular telephones, smartphones, tablets, portable computers, laptop computers, personal digital assistants, wearable devices, watches, eyeglasses, goggles, media players vehicle displays, and the like. In another example, the e-commerce user interface 106 may be a website of an e-commerce retailer accessible by a computer or mobile device. The e-commerce user interface 106 may allow a user to log into an account associated with the user and the e-commerce retailer, browse products 121 for purchase, add products 121 to a virtual cart, place orders, and so forth.

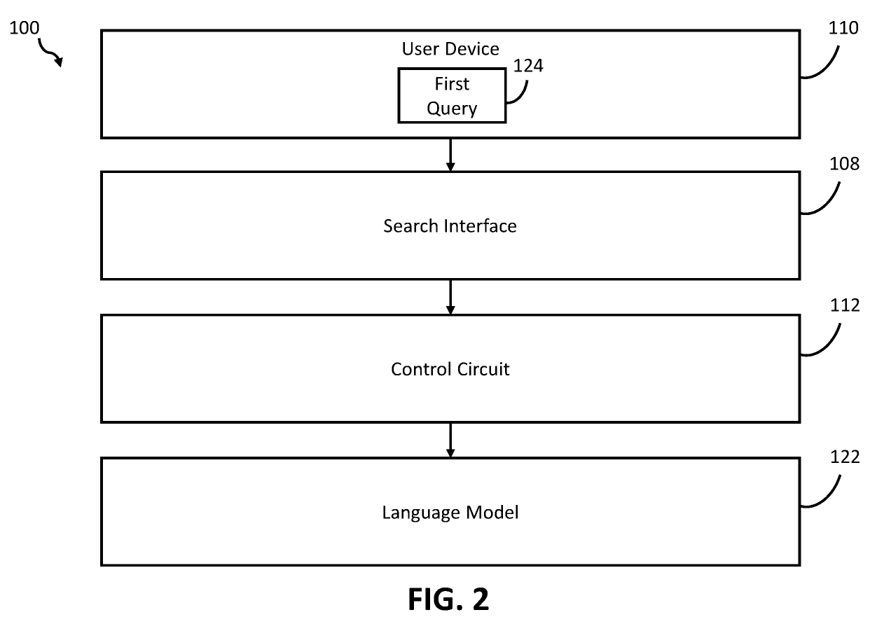

Further referring to FIG. 2, the search interface 108 may be a search platform associated with the e-commerce user interface 106 in accordance with some embodiments. For example, the search interface 108 may be a search bar and/or search screen of the e-commerce user interface 106, which a user may utilize to input search terms or parameters. Generally, the search interface 108 may be used to find products available for purchase at the e-commerce retailer relevant to queries 124. Non-limiting examples of queries 124 which may be searched via the search interface 108 include, for instance, a question, product characteristic, product purpose, and the like. In some embodiments, the search interface 108 may be a multi-modal search interface 108, such that a user can enter multiple queries 124 in multiple search modalities. The search interface 108 can include a plurality of search modality options in accordance with some embodiments. In some aspects, a query 124 can include at least one of a text search, an image search, a video search, an audio search, a barcode search, a color search, and/or a URL search. In some embodiments, a text search may include simple text strings in addition to broader semantic phrases. It should be understood that suitable search modality options are not limited to the described modalities. Instead, it is generally contemplated that the search interface 108 may be provided to a user device 110 and may be configured to receive a query 124 in any suitable search modality, and that the provided examples are non-exhaustive. For example, a user searching for a coat to purchase may use their mobile phone (i.e., the user device) to select and open an application associated with the retailer (i.e., the e-commerce user interface). The user may navigate to a search screen (i.e., the search interface), which displays a search bar with multiple selectable options associated with multiple types of input (i.e., the search modalities). For example, the user may input an image of a coat similar to what they are interested in finding, a desired color of the coat, and text regarding a desired length of the coat. In response to the inputs, a listing of products may be generated including coats that look like the coat in the image that are also the desired color and length. The multiple types of input (i.e., the image, the color, and the text) may be input and utilized together in order to generate relevant search results.

In some embodiments, the user devices 110 may be operatively coupled to the any described components of the search query system 100 and may include, but are not limited to, smartphones, tablets, laptops, computers, and/or other such computing systems that enable a user to communicate with the search query system 100. In some aspects, one or more user devices 110 may be part of the search query system 100 and/or one or more user devices 110 may be separate and distinct from the search query system 100. The search query system 100 can further include and/or be in communication with one or more networks 104 and/or communication interfaces 102. The user device(s) 110 can allow a user to interact with the search query system 100 and receive information through the system. In some instances, the user device 110 includes a display and/or one or more user inputs, such as buttons, touch screen, track ball, keyboard, mouse, etc., which can be part of or wired or wirelessly coupled with the search query system 100.

The computer readable storage memory 114 may store a product database 118 and a set of computer executable instructions 116 in accordance with some embodiments. The product database 118 includes/stores a plurality of product records 120 each being associated with a set of search vectors and being associated with products 121. Examples of suitable computer readable storage memory 114 includes random access memory (RAM), read-only memory (ROM), erasable programmable read-only memory (EPROM/flash memory), and so forth, and may include transient and/or non-transient mediums. The computer readable storage memory 114 typically includes one or more processor-readable and/or computer-readable media accessed by at least the control circuit 112, and can include volatile and/or nonvolatile media, such as RAM, ROM, EEPROM, flash memory and/or other memory technology. The computer readable storage memory 114, while shown as external to the control circuit 112, can be internal, external, or a combination of internal and external memory of the control circuit 112. While one computer readable storage memory 114 is shown storing both computer executable instructions 116 and the product database 118, it is generally contemplated that there may be any additional number of computer readable storage memory 114 such as, for example, a first computer readable storage memory 114 storing the computer executable instructions 116 and a second computer readable storage memory 114 storing the product database 118. In some embodiments, the product database 118 may be any suitable database (e.g., hierarchical databases, relational databases, non-relational databases, object oriented databases, and so forth) configured to store data relevant to the search query system 100. In some embodiments, the product database 118 stores data which may include product data (e.g., product characteristics, product name, product descriptions, and so forth), historical query data, product vectors 123, search vectors 136, etc.

In some embodiments, the control circuit 112 is configured to execute the computer executable instructions 116. The control circuit 112 may include any suitable processing resource configured to execute instructions (e.g., the computer executable instructions 116) stored in a computer-readable storage memory (e.g., a non-transitory, computer-readable storage medium and/or the computer readable storage memory 114). In this context, the terms control circuit 112 and controller refer broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The computer executable instructions 116 may, for example, be code, software, programming, executables, scripts, etc., executable by the control circuit 112 and/or other computing devices. The control circuit 112 or controller may be configured (for example, by using corresponding programming stored in a memory as will be well understood by those skilled in the art) to carry out one or more of the steps, actions, and/or functions described herein.

In some embodiments, the language model 122 may be any suitable trained machine learning model, including decision trees, random forest, neural networks, deep learning, and so forth. In some embodiments, the language model 122 is a large language model. In the present embodiment, the language model 122 may be operatively coupled with the control circuit 112 via the network 104, and the control circuit 112 may execute the language model 122. In some embodiments, instructions stored in memory (e.g., of the control circuit 112 and/or external memory) may cause the control circuit 112 to output information and/or data from the user device(s) 110, the product database 118, the communication interface 102, and/or the e-commerce user interface 106, to be used by the language model 122. The language model 122 is generally pre-trained with data, and in some embodiments may be re-trained by any combination of manually input re-training data and/or self-learning methods. It is generally contemplated that more than one language model 122 may be used for any combination of the actions described herein.

As shown in FIG. 2, a first query 124 can be received by the control circuit 112 from a user device 110 via the search interface 108. In some embodiments, a query 124 may be converted to a text string or an encoded image to be input into the language model 122 regardless of the search modality (i.e., the language model 122 may be a large language model or a vision language model able to receive input as text or images respectively, and not alternative search modalities that a user is able to enter a query 124 in). Any suitable model (e.g., machine learning and/or alternate software models) may convert any non-text and/or non-image search modalities into text and/or images in accordance with some embodiments.

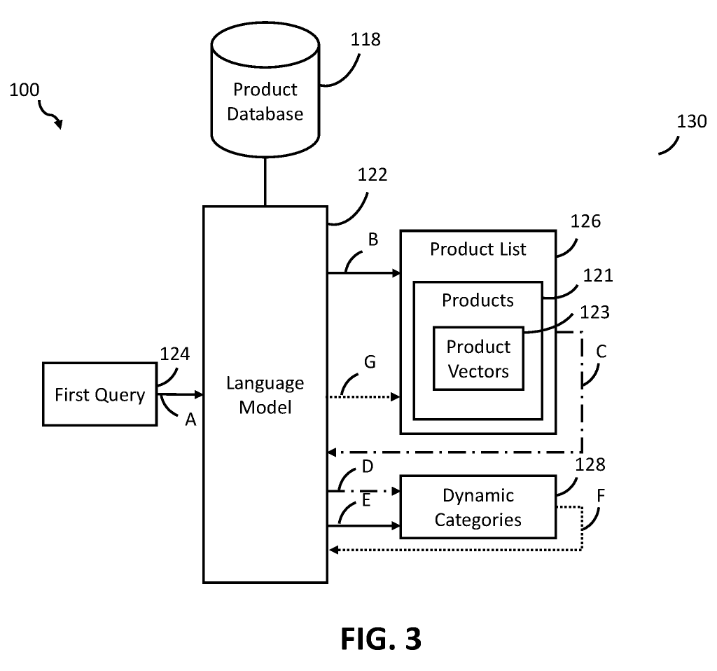

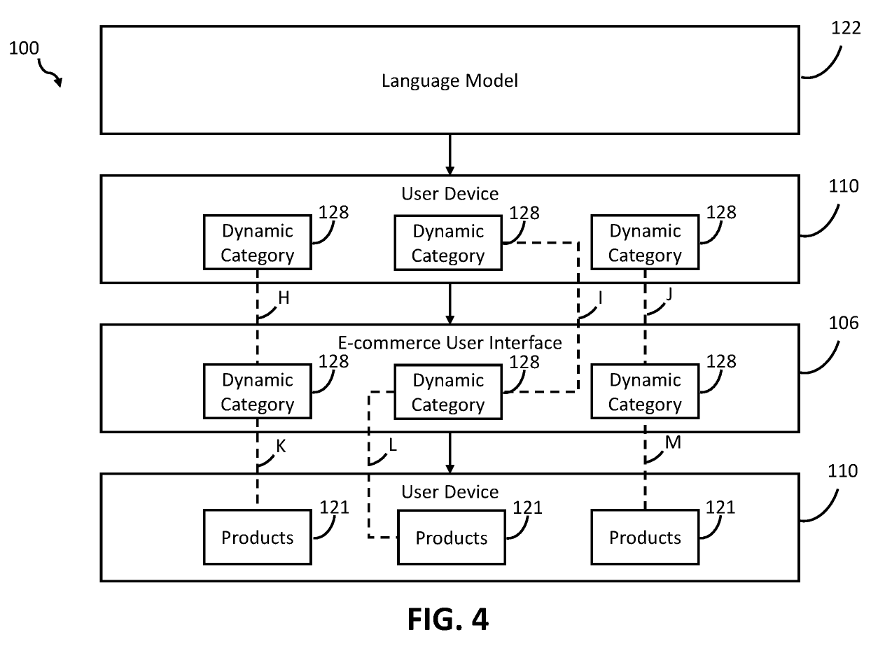

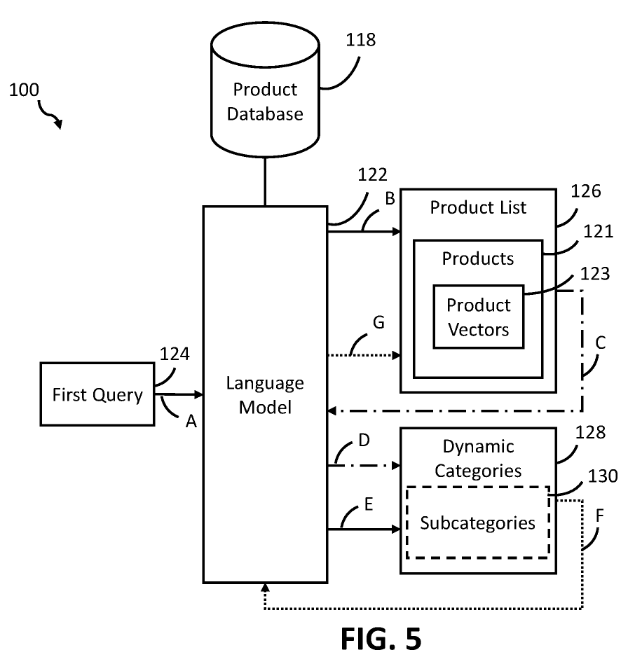

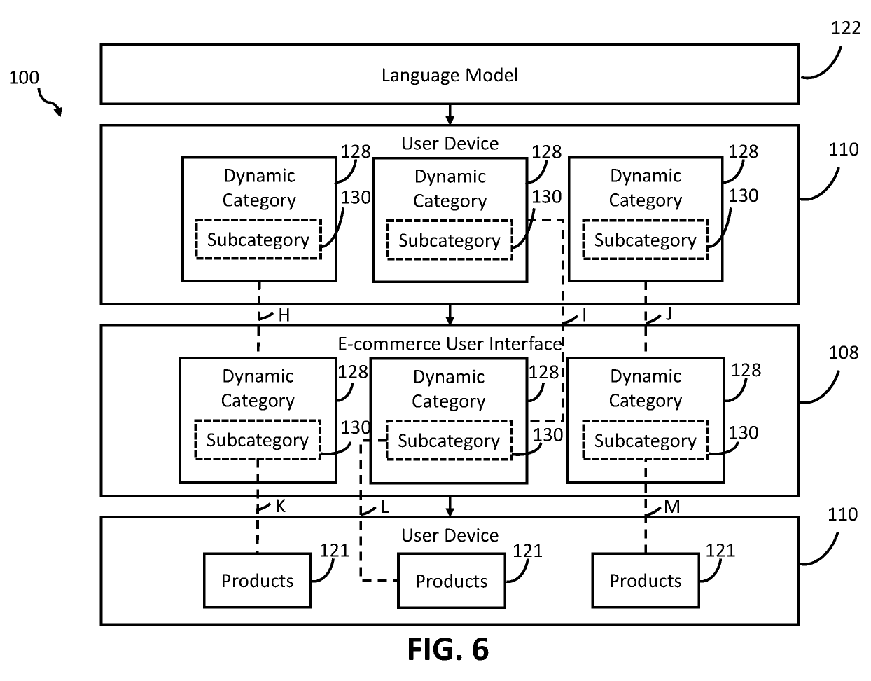

Further referring to FIGS. 3 and 4, since the control circuit 112 and the language model 122 are communicatively coupled, the control circuit 112 may generate, via the language model 122, a product list 126 including a plurality of products 121 based on at least the first query 124 and the product database 118. In other words, after receiving a query 124 from a user, the search query system 100 generates a product list 126 that includes at least one product 121 related to the query 124 (e.g., a text search for ‘purple toys’ would generate a product list 126 including products 121 most relevant to ‘purple toys’). The control circuit 112 may further generate, via the language model 122, two or more dynamic categories 128 based on product vectors 123 of the plurality of products 121 in the product list 126. It is generally contemplated that any additional information (e.g., historical data, customer data, selected search terms, selected product bundles, additional queries 124, and so forth) may be used to generate the product list 126, the dynamic categories 128, and/or the subcategories 130 (shown in FIGS. 5 and 6).

Referring to FIG. 3, the solid line A represents the first query 124 being received by the language model 122, and the solid line B represents the product list 126 being generated based on the first query 124. The broken line C represents the product list 126 being input back into the language model 122 to be recursively used for further generation and/or updating of the product list 126 and/or of the dynamic categories 128. The broken line D represents the product list 126 being used by the language model 122 to generate the dynamic categories 128, and the solid line E represents the first query 124 being used by the language model 122 to generate the dynamic categories 128. The dashed line F represents the dynamic categories 128 being input back into the language model 122 to be recursively used for further updating and/or generation. The dashed line G represents a selected dynamic category 128 being used by the language model 122 to update the product list 126 along with the first query 124 and the product database 118.

Further referring to FIG. 4, the control circuit 112 may provide, for display on a user device 110, the dynamic categories 128 for selection on the e-commerce user interface 106. Generally, the selection of a dynamic category 128 triggers the display of a subset of products 121 in the product database 118 associated with the dynamic category 128. The dashed lines H and K represent an association between a first dynamic category (which is displayed on the user device 110 and selected in the e-commerce user interface 106) and a first subset of products 121 displayed on the user device 110. The dashed lines I and L represent an association between a second dynamic category (which is displayed on the user device 110 and selected in the e-commerce user interface 106) and a second subset of products 121 displayed on the user device 110. The dashed lines J and M represent an association between a third dynamic category (which is displayed on the user device 110 and selected in the e-commerce user interface 106) and a third subset of products 121 displayed on the user device 110. While three dynamic categories 128 and associated subsets of products 121 are shown in FIG. 4, it is generally contemplated that any number of dynamic categories (e.g., one, two, three, four, etc.) can be generated and displayed for selection. Generally, more than one dynamic category 128 may be generated, and the dynamic categories 128 generated may be related to the query 124 entered. For example, a text search for “purple toys” may generate categories of “children’s birthday gifts”, “purple children’s items”, “children’s toys” and so forth. The dynamic categories 128 are generally related to aspects of the query 124 and may go beyond the query 124 to broaden and/or pivot the initial search and provide additional related products 121. For example, the subset of products 121 associated with a dynamic category 128 may include a subset of products 121 of the product list 126 but may alternately/additionally include a subset of products 121 from the product database 118 that is not in the product list 126.

Further referring to FIGS. 5 and 6, the control circuit 112 may further generate, via the language model 122, at least one subcategory 130, and provide, for display on a user device 110, the at least one subcategory 130 for selection in the e-commerce user interface 106. As shown in FIG. 5, the dynamic categories 128 further include at least one respective subcategory 130. For example, a dynamic category 128 of “children’s birthday gifts” may include subcategories 130 of “toys ages 5+”, “games”, “action figures”, and so forth. The subcategories 130 generally include a subset of products 121 that is narrowed relative to a subset of products 121 in a respective dynamic category 128. However, it is generally contemplated that in some embodiments a subcategory 130 may include a subset of products 121 not included in a respective dynamic category 128 (e.g., products 121 in the product list 126 and/or the product database 118 not in the dynamic categories 128). The dashed line G in FIG. 5 further represents, in the present embodiment, the product list 126 being updated by the language model 122 based on the selection of a subcategory 130 in addition to the first query 124 and the product database 118. In some embodiments, multiple dynamic categories 128, and/or subcategories 130 may be selected successively such that the product list 126 is updated relative to multiple dynamic categories 128 and/or subcategories 130.

FIG. 6 further shows a first subcategory 130 being associated with a first dynamic category 128 and respective products 121 as described herein, a second subcategory 130 being associated with a second dynamic category 128 and respective products 121 as described herein, and/or a third subcategory 130 being associated with a third dynamic category 128 and respective products 121 as described herein. While three dynamic categories 128 each including a respective subcategory 130 are shown in FIG. 6, it is generally understood that a dynamic category 128 may include any additional number of subcategories 130 (e.g., one, two, three, etc.). While each dynamic category 128 and respective subcategory 130 are further shown to be associated with a respective set of products 121, it is generally contemplated that a dynamic category 128 and a respective subcategory 130 may each be associated with a different subset of products 121. Generally, the selection of a dynamic category 128 and/or a subcategory 130 may not replace the original subset of products 121 in the product list 126 with the subset of products 121 associated with the selected dynamic category 128 and/or subcategory 130, but instead may use the selected dynamic category 128 and/or subcategory 130 as input into the language model 122 when generating/updating the product list 126 and/or adds the subset of products 121 in the selected dynamic category 128 and/or subcategory 130 to the product list 126.

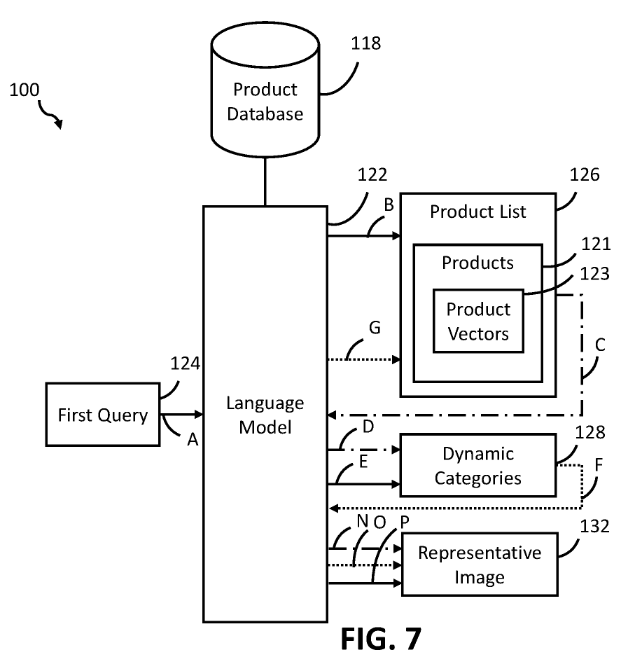

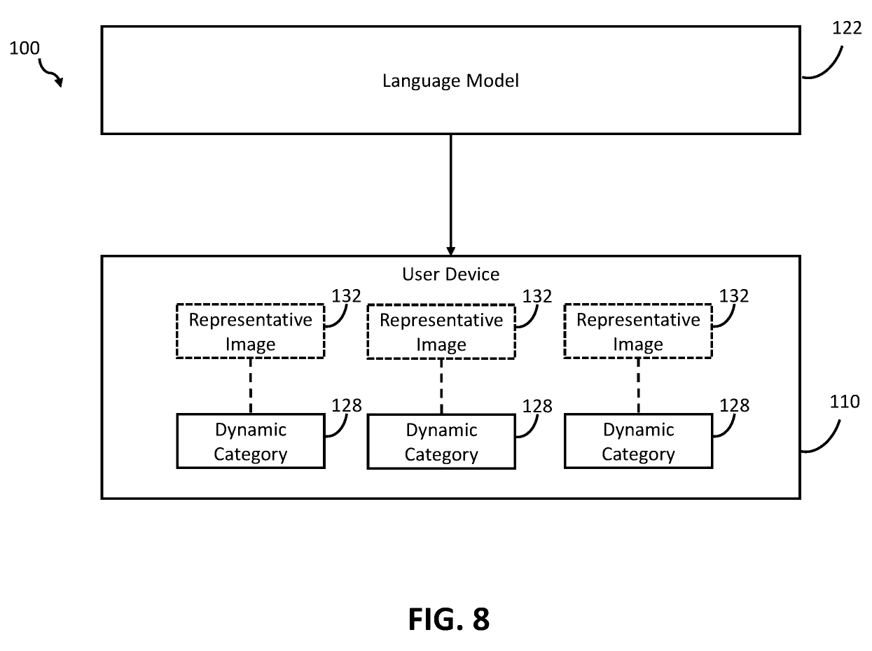

Further referring to FIGS. 7 and 8, in some embodiments, the control circuit 112 further generates, via the language model 122, at least one representative image 132 based on the product list 126. In one example, a query for “purple toys” with a respective dynamic category of “children’s birthday gifts” may have a corresponding representative image 132 of a child in a birthday hat playing with a toy. Generally, the representative images 132 may be related to the respective dynamic category 128 and/or query 124 and portrays related items, actions, etc., of the suggested dynamic categories 128. The dashed line N in FIG. 7 represents the product list 126 being used by the language model 122 for generating the representative image. In some embodiments, the representative image 132 may further be generated by the language model 122, as represented by the solid like P, based on a query 124. In some embodiments, each representative image 132 may correspond to a respective dynamic category 128, and the dashed line O in FIG. 7 represents a dynamic category 128 being used by the language model 122 to generate the respective representative image 132. Referring to FIG. 8, the control circuit 112 may further provide, for displaying on a user device 110, at least one representative image 132.

As shown in FIG. 8, three representative images 132 (each corresponding to a respective dynamic category 128) are displayed on the user device 110. It is generally contemplated that additional representative images 132 may be generated (e.g., such that multiple representative images 132 correspond with a singular dynamic category 128, representative images 132 correspond with subcategories 130, and so forth). In some embodiments, representative images 132 may be generated for a subset of dynamic categories 128 and not all dynamic categories 128. Any suitable number of representative images 132 may be generated and associated with any suitable number of dynamic categories 128 and/or subcategories 130. While FIGS. 7 and 8 show the representative image(s) 132 to be generated by the same language model 122 as the product list 126 and the dynamic categories 128, it is generally contemplated that the product list 126, the dynamic categories 128, the subcategories 130, and/or the representative images 132 may be generated by any combination of the same language model 122 and/or additional/alternative language models 122.

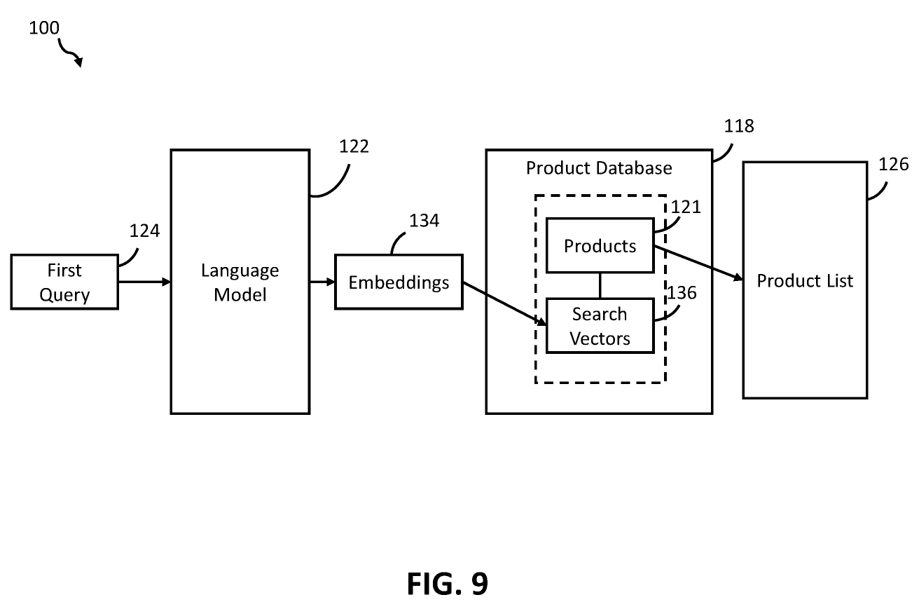

Further referring to FIG. 9, the search query system 100 is shown in accordance with some embodiments. In some aspects, the generation of the product list 126 may further include receiving embeddings 134 associated with the first query 124 from the language model 122, and identifying a plurality of products 121 from the plurality of product records 120 stored in the product database 118 by matching the embeddings 134 associated with the first query 124 with search vectors 136 associated with products 121 in the product database 118. It is generally contemplated that embeddings 134 may be generated for any number of respective queries 124. Any suitable embedding model may be used to generate the embeddings 134 received by the control circuit 112. In some embodiments, the language model 122 may generate the embeddings 134 associated with the queries 124.

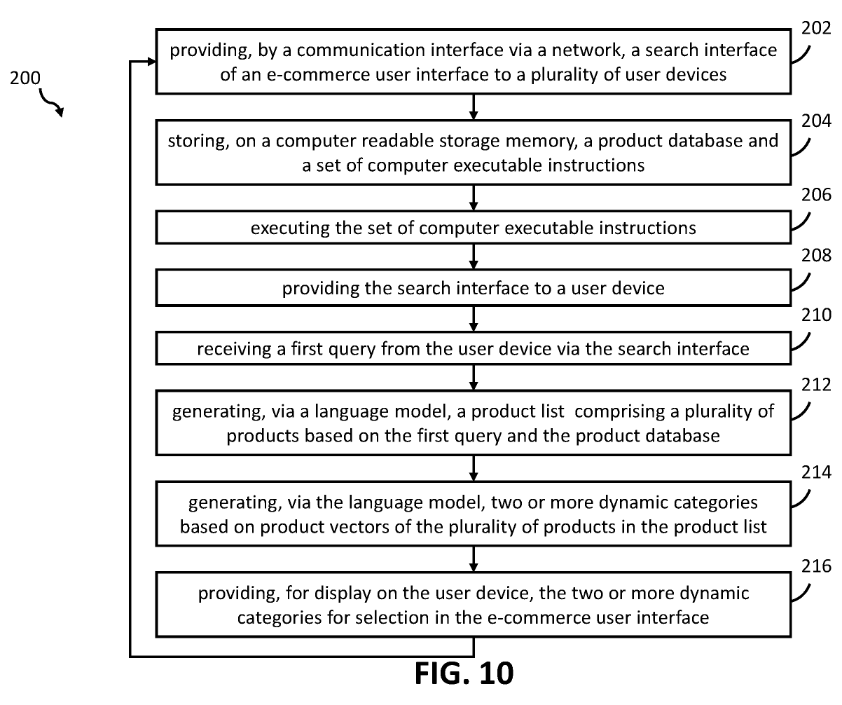

FIGS. 10-13, show a method 200 for providing search results in accordance with some embodiments. Generally, the method 200 may be implemented by the search query system 100 and/or components of the search query system 100 described herein. Referring to FIG. 10, the method 200 includes a step 202 of providing, by a communication interface via a network, a search interface of an e-commerce user interface to a plurality of user devices. At a step 204, the method 200 includes storing, on a computer readable store memory, a product database, and a set of computer executable instructions. Generally, the product database may include a plurality of product records, each associated with a set of search vectors. At step 206, the method 200 includes executing the set of computer executable instructions. The instructions are generally executed by a processor-based device and/or processing resource.

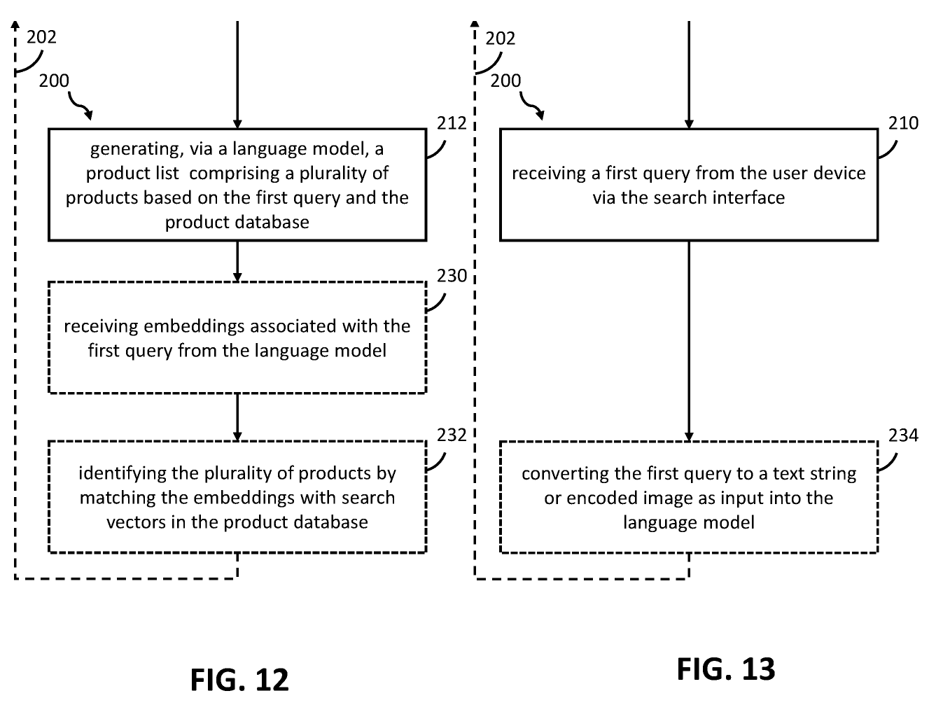

The proceeding steps are generally in response to the execution of the computer executable instructions at step 206. At step 208, the method 200 further includes providing the search interface to a user device. The method 200 includes a step 210 of receiving a first query from the user device via the search interface. In some embodiments, the first query may include at least one of a text search, an image search, a video search, an audio search, a color search, a URL search, and/or a barcode search. Further referring to FIG. 13, in some embodiments the method 200 further includes a step 234 of converting the first query to a text string or an encoded image as input into the language model. Step 212 of the method 200 includes generating, via a language model, a product list comprising a plurality of products based on the first query and the product database. In some embodiments, as shown in FIG. 12, step 212 of the method 200 further includes a step 230 of receiving embeddings associated with the first query from the language model, and a step 232 of identifying the plurality of products from the plurality of product records by matching the embeddings associated with the first query with search vectors associated with products in the product database. At step 214, as shown in FIG. 10, the method 200 includes generating, via the language model, two or more dynamic categories based on product vectors of the plurality of products in the product list. In some embodiments, the subset of products associated with the dynamic category may include a subset of the plurality of products in the product list. At step 216, the method 200 includes providing, for display on the user device, the two or more dynamic categories for selection in the e-commerce user interface. A selection of a dynamic category may further trigger the display of a subset of products in the product database associated with the dynamic category.

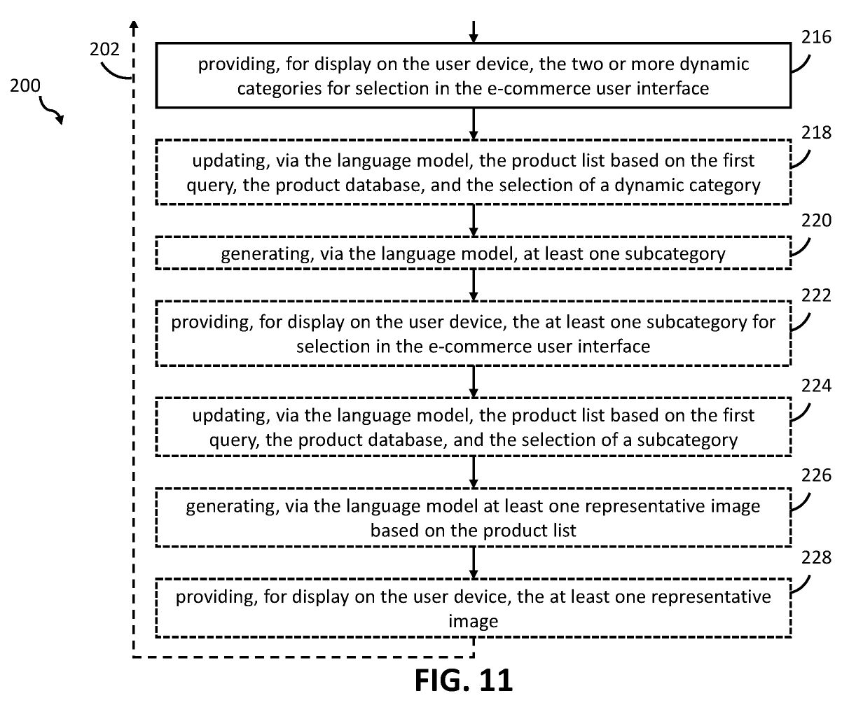

Now referring to FIG. 11, the method 200 may further include any of the following optional steps 218, 220, 222, 224, 226, 228. Proceeding step 216, the method 200 may further include a step 218 of updating, via the language model, the product list based on the first query, the product database, and the selection of a dynamic category. In some embodiments, the method 200 may further include a step 220 of generating, via the language model, at least one subcategory, and a step 222 of providing, for display on the user device, the at least one subcategory for selection in the e-commerce user interface. In some aspects, each of the two or more dynamic categories includes at least one respective subcategory. In further embodiments, the method 200 may include a step 224 of updating, via the language model, the product list based on the first query, the product database, and the selection of a subcategory. In some embodiments, the method 200 further includes a step 226 of generating, via the language model, at least one representative image based on the product list, and a step 228 of providing the at least one representative image for display on the user device. In some embodiments, each representative image of the at least one representative image corresponds to a respective category of the two or more dynamic categories.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system for providing product search results, the system comprising:
a communication interface configured to provide, via a network, a search interface of a user interface to a plurality of user devices;
a computer readable storage memory storing a product database and a set of computer executable instructions, wherein the product database comprises a plurality of product records each associated with a set of search vectors; and
a control circuit configured to execute the set of computer executable instructions, which causes the control circuit to:
provide the search interface to a user device;
receive a first query from the user device via the search interface;
generate, via a language model, a product list comprising a plurality of products based on the first query and the product database;
generate, via the language model, two or more dynamic categories based on product vectors of the plurality of products in the product list; and
provide, for display on the user device, the two or more dynamic categories for selection in the user interface, wherein the selection of a dynamic category triggers the display of a subset of products in the product database associated with the dynamic category.

2. The system of claim 1, wherein the subset of products associated with the dynamic category includes a subset of the plurality of products of the product list.

3. The system of claim 1, wherein generating the product list comprises:
receiving embeddings associated with the first query from the language model; and
identifying the plurality of products from the plurality of product records by matching the embeddings associated with the first query with search vectors associated with products in the product database.

4. The system of claim 1, wherein the first query is converted to a text string or an encoded image as input into the language model.

5. The system of claim 1, wherein the control circuit further:
updates, via the language model, the product list based on the first query, the product database, and the selection of the dynamic category.

6. The system of claim 1, wherein the control circuit further:
generates, via the language model, at least one subcategory; and
provides, for display on the user device, the at least one subcategory for selection in the user interface;
wherein each of the two or more dynamic categories comprises at least one respective subcategory.

7. The system of claim 6, wherein the control circuit further:
updates, via the language model, the product list based on the first query, the product database, and the selection of a subcategory.

8. The system of claim 1, wherein the control circuit further:
generates, via the language model, at least one representative image based on the product list; and
provides, for display on the user device, the at least one representative image.

9. The system of claim 8, wherein each representative image of the at least one representative image corresponds to a respective category of the two or more dynamic categories.

10. The system of claim 1, wherein the first query comprises at least one of a text search, an image search, a video search, an audio search, a color search, a URL search, or a barcode search.

11. A method for providing product search results, the method comprising:
providing, by a communication interface via a network, a search interface of a user interface to a plurality of user devices;
storing, on a computer readable storage memory, a product database, and a set of computer executable instructions, wherein the product database comprises a plurality of product records each associated with a set of search vectors;
executing the set of computer executable instructions;
providing the search interface to a user device;
receiving a first query from the user device via the search interface;
generating, via a language model, a product list comprising a plurality of products based on the first query and the product database;
generating, via the language model, two or more dynamic categories based on product vectors of the plurality of products in the product list; and
providing, for display on the user device, the two or more dynamic categories for selection in the user interface, wherein the selection of a dynamic category triggers the display of a subset of products in the product database associated with the dynamic category.

12. The method of claim 11, wherein the subset of products associated with the dynamic category includes a subset of the plurality of products of the product list.

13. The method of claim 11, wherein the generating the product list comprises:
receiving embeddings associated with the first query from the language model; and
identifying the plurality of products from the plurality of product records by matching the embeddings associated with the first query with search vectors associated with products in the product database.

14. The method of claim 11, the method further comprising:
converting the first query to a text string or an encoded image as input into the language model.

15. The method of claim 11, the method further comprising:
updating, via the language model, the product list based on the first query, the product database, and the selection of the dynamic category.

16. The method of claim 11, the method further comprising:
generating, via the language model, at least one subcategory; and
providing, for display on the user device, the at least one subcategory for selection in the user interface;
wherein each of the two or more dynamic categories comprises at least one respective subcategory.

17. The method of claim 16, the method further comprising:
updating, via the language model, the product list based on the first query, the product database, and the selection of a subcategory.

18. The method of claim 11, the method further comprising:
generating, via the language model, at least one representative image based on the product list; and
providing, for display on the user device, the at least one representative image.

19. The method of claim 18, wherein each representative image of the at least one representative image corresponds to a respective category of the two or more dynamic categories.

20. The method of claim 11, wherein the first query comprises at least one of a text search, an image search, a video search, an audio search, a color search, a URL search, or a barcode search.
